(19) United States
(12) Patent Application Publication
(10) Pub. No.: US 2015/0049026 A1
(43) Pub. Date: Feb. 19, 2015

(54) HANDHELD ELECTRONIC DEVICE AND INPUT OPERATION METHOD OF THE SAME

(71) Applicant: HTC Corporation, Taoyuan County (TW)

(72) Inventors: Ming-Yu CHEN, Taoyuan County (TW); Hsin-Hao LEE, Taoyuan County (TW); Tsung-Pao KUAN, Taoyuan County (TW)

(73) Assignee: HTC Corporation, Taoyuan County (TW)

(21) Appl. No.: 13/966,291

(22) Filed: Aug. 14, 2013

(51) Int. Cl. G06F 3/0488

(52) U.S. Cl. CPC G06F 3/04886
USPC 345/173

(57) ABSTRACT

A handheld electronic device is provided. The handheld electronic device includes a storage unit, a touch display unit and a processing unit. The storage unit stores a first program. The touch display unit displays an input interface of a second program, in which the input interface includes virtual keys. The processing unit is electrically connected to the storage unit and the touch display unit. The processing unit determines that a first program activation signal is received when the input interface is displayed on the touch display unit and executes the first program in the storage unit such that the first program to processes the operation input of the input interface.

### BACKGROUND

1. Technical Field

The present disclosure relates to an input technology of an electronic device. More particularly, the present disclosure relates to a handheld electronic device and an input operation method of the same.

2. Description of Related Art

Handheld electronic devices are essential communication tools for people in the daily life for most people. Besides the ability of communication, the handheld electronic devices are equipped with increasing abilities of data operation and data processing. The combination of the data operation ability and the communication ability makes the handheld electronic devices such as the tablet PCs or the smartphones reminiscent to small computers. It is convenient to edit documents, navigate the network, receive e-mails and deliver e-mails by using the handheld electronic devices.

Similar to the condition of operating a normal computer, the user may operate different application software at the same time. For example, the user may want to edit a document file and inquire words by using a network navigating software at the same time. In another condition, the user may want to edit a document file and calculate statistics at the same time. However, the size of the screen of the handheld electronic device is limited and is not able to display interfaces of a multiple of software. A complicated process is needed to switch between interfaces of different software when the user wants to perform different application software at the same time. The switching process is time-consuming and is not easy to use. For a handheld electronic device that is designed to bring conveniences, the above condition is a serious drawback.

Accordingly, what is needed is a handheld electronic device and an input operation method of the same to address the above issues.

### SUMMARY

An aspect of the present invention is to provide a handheld electronic device. The handheld electronic device includes a storage unit, a touch display unit and a processing unit. The storage unit stores a first program. The touch display unit displays an input interface of a second program, in which the input interface includes a plurality of virtual keys. The processing unit is electrically connected to the storage unit and the touch display unit. The processing unit determines that a first program activation signal is received when the input interface is displayed on the touch display unit and executes the first program in the storage unit such that the first program processes the operation input of the input interface.

Another aspect of the present invention is to provide an input operation method used in a handheld electronic device, wherein the handheld electronic device comprises a storage unit to store a first program, a touch display unit and a processing unit electrically connected to the storage unit and the touch display unit. The input operation method includes the steps outlined below. An input interface of a second program is displayed by the touch display unit, wherein the input interface comprises a plurality of virtual keys. A first program activation signal is determined to be received by the processing unit when the input interface is displayed on the touch display unit. The first program in the storage unit is executed by the processing unit. The operation input of the input interface is processed by the processing unit according to the first program.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1A is a block diagram of a handheld electronic device in an embodiment of the present invention;

FIG. 1B is a top view of the handheld electronic device in FIG. 1A in an embodiment of the present invention;

FIGS. 2A and 2B are top views of the handheld electronic device in an embodiment of the present invention;

FIG. 3 is a top view of the handheld electronic device in another embodiment of the present invention;

FIG. 4 is a top view of the handheld electronic device in yet another embodiment of the present invention; and

FIG. 5 is a flow chart of an input operation method of an embodiment of the present invention.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

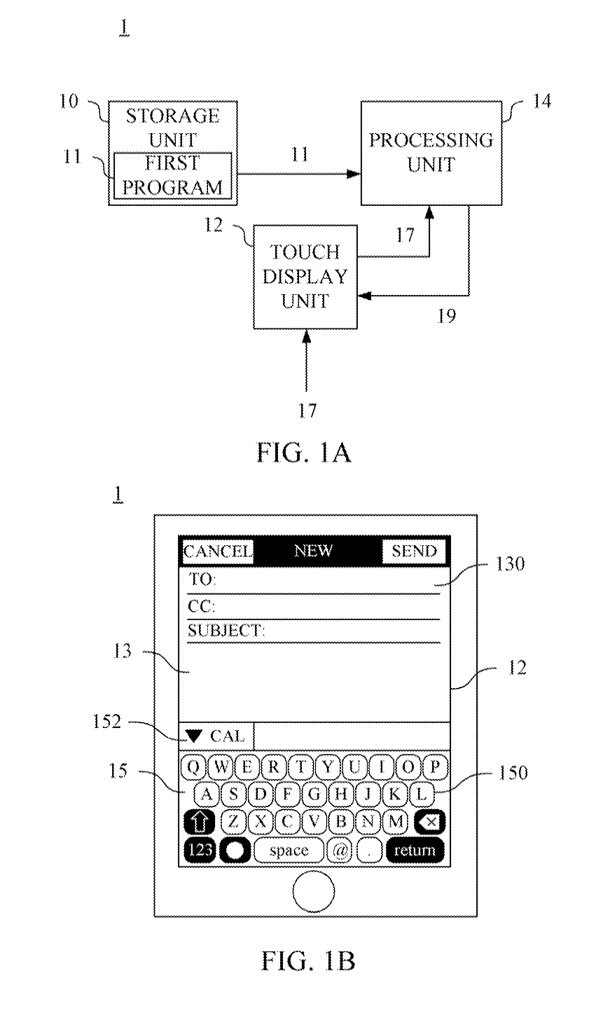

FIG. 1A is a block diagram of a handheld electronic device 1 in an embodiment of the present invention, FIG. 1B is a top view of the handheld electronic device 1 in FIG. 1A in an embodiment of the present invention. The handheld electronic device 1 includes a storage unit 10, a touch display unit 12 and a processing unit 14.

The storage unit 10 stores a first program 11. The first program 11 can be, but not limited to, tool software of a calculator, a dictionary, a notebook or a network search engine. Take these tool software as examples, the tool software of the calculator generates computation results according to the input of the numbers and operations. The tool software of the dictionary and the network search engine generates inquiry results according to the input of the keywords. The tool software of the notebooks selectively generates a stored result according to the input of the characters. Hence, the first program 11 performs data processing according to the corresponding operation input and generates an operation result.

The touch display unit 12 displays frames based on different operation conditions of the handheld electronic device 1. In an embodiment, the touch display unit 12 displays the frames according to the display data transmitted by the processing unit 14. The processing unit 14 is electrically connected to the storage unit 10 and the touch display unit 12 to access the storage unit 10, perform processing according to the input of the touch display unit 12 and output the operation result such that the touch display unit 12 displays the result.

As illustrated in FIG. 1B the touch display unit 12 displays a second interface 13 and the input interface 15 of the second program under the control of the processing unit 14. In the present embodiment, the input interface includes a plurality of virtual keys 150 and a first program activation key 152. In different embodiments, the input interface 15 is displayed instantly when the second program is activated or is displayed when an input field 130 of the second interface 13 is triggered.

The processing unit 14 determines whether a first program activation signal 17 is received when the input interface 15 is displayed on the touch display unit 12. In the present embodiment, the first program activation signal 17 is generated when the first program activation key 152 is triggered. When the first program activation key 152 is triggered, the processing unit 14 receives the first program activation signal 17 to retrieve and execute the first program 11 in the storage unit 10.

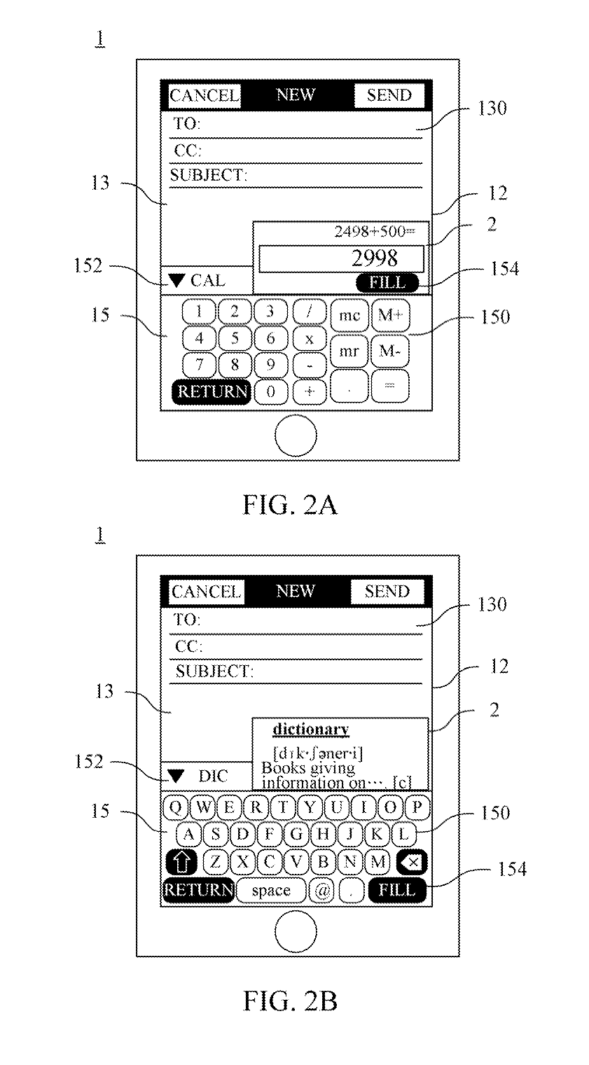

FIGS. 2A and 28 are top views of the handheld electronic device 1 in an embodiment of the present invention. After the processing unit 14 determines that a first program activation signal 17 is received, the processing unit 14 executes the first program 11 in the storage unit 10 and displays the first interface 2 corresponding to the first program 11 on the second interface 13.

The processing unit 14 further performs data processes on an operation input of the input interface 15 according to the first program 11 to generate a operation result 19. In an embodiment, the input interface 15 adjusts its layout according the activation of different types of first program 11. For example, as illustrated in FIG. 2A, the processing unit 14 adjusts the layout of the input. interface to show the number keys and the operation keys when the first program 11 is tool software of the calculator. The virtual keys 150 including the number keys and the operation keys receive the operation input of the user including the numbers and the operations to perform calculation and generate the calculated result.

When the first program 11 is tool software of the dictionary or the network search engine, such as the example of dictionary illustrated in FIG. 2B, the processing unit 14 adjusts the layout of the input interface 15 to show character keys and receives words or characters from the operation input of the user through these virtual keys 150. The processing unit 14 further performs inquiry according to the inputted words or characters to generate an inquiry result. When the first program 11 is tool software of the notebook (not shown), the processing unit 14 receives the inputted words or the characters from the operation input of the user through these virtual keys 150. The processing unit 14 further selectively generates a stored result or simply displays the words or the characters on the touch display units 12.

In an embodiment, the display of the first interface 2 does not fully cover the second interface 13 such that the user can view and refer to the content of the second interface 13, as illustrated in FIGS. 2A and 2B. In the present embodiment, the input interface 15 further includes an output key 154 as illustrated in FIG. 2A. When the output key 154 is triggered, the processing unit 14 outputs the operation result (e.g. the calculated result, the inquiry result, the stored result or the displayed result described above) of the first program 11 corresponding to the operation input to the second program. In an embodiment, the operation result is directly filled to the input field 130 of the second interface 13 corresponding to the second program. In an embodiment, the output key 154 is displayed on the second interface 13. In another embodiment, the position of the output key 154 is disposed together with the other virtual keys 150 of the input interface 15 as illustrated in FIG. 2B to accomplish the same function.

For example, when the user needs to perform calculation on statistics or perform inquiry on words when an e-mail is edited by using the application program of the e-mail (i.e. the second program), the user can display the first interface 2 by using the methods mentioned above. The data processing is further performed by the first program 11 according to the operation input from the input interface 15. The operation result, such as the calculated result or the inquiry result, is directly outputted to the application program of the e-mail (e.g. the field of the context of the e-mail) by triggering the output key 154. The switching from the first program to the second program is unnecessary. Further, the operation result of the first program can be outputted to the second program conveniently.

Based on the design of the handheld electronic device 1 of the present invention, if the user wants to perform data processing by using the first program 11 when the second program is executed, the user can directly activate the first program 11 through the input interface 15. Subsequently, the first program 11 can process the operation input from the input interface 15. The switching from the first program to the second program is unnecessary and the efficiency of process of the operation input of the handheld electronic device 1 is increased.

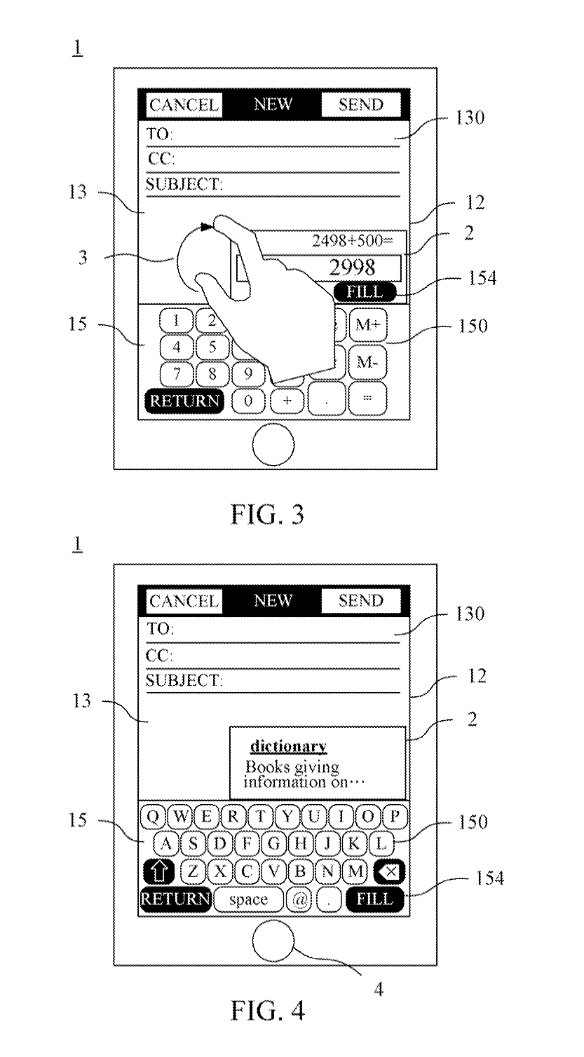

FIG. 3 is a top view of the handheld electronic device 1 in another embodiment of the present invention. In the present embodiment, the first program activation signal 17 is generated when the touch display unit 12 detects the touch track 3. In other embodiments, various touch tracks or touch gestures are used depending on different applications and are not limited to the example shown in the present embodiment. Therefore, the processing unit 14 can execute the first program according to the touch track or the touch gesture applied on the touch display unit 12. The switching from the first program to the second program is unnecessary and the efficiency of process of the operation input of the handheld electronic device 1 is increased.

FIG. 4 is a top view of the handheld electronic device 1 in yet another embodiment of the present invention. In the present embodiment, the handheld electronic device 1 further includes a physical key 4. The first program activation signal 17 is generated when the physical key 4 is triggered. In other embodiments, various numbers and the positions of the physical key 4 are used depending on different applications and are not limited to the example shown in the present embodiment. Therefore, the processing unit 14 can execute the first program by triggering the physical key 4. The switching from the first program to the second program is unnecessary and the efficiency of process of the operation input of the handheld electronic device 1 is increased.

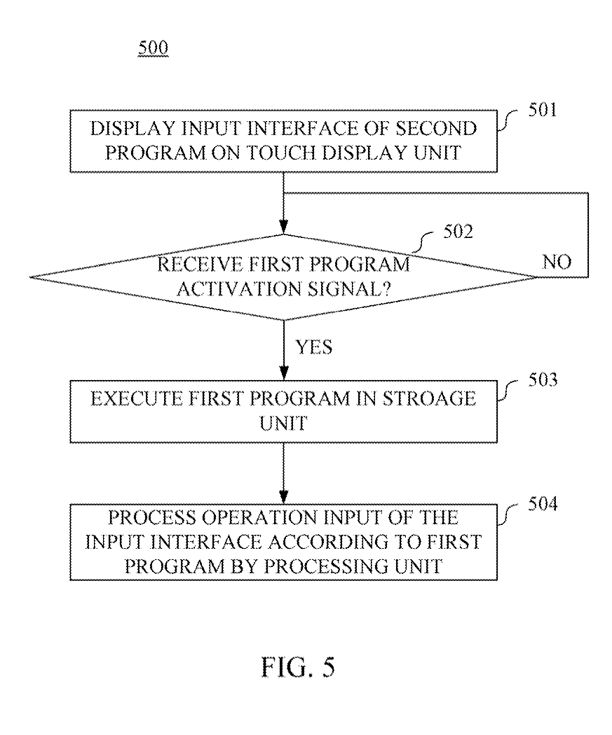

FIG. 5 is a flow chart of an input operation method 500 of an embodiment of the present invention. The input operation method 500 is used in the handheld electronic device 1 illustrated in FIGS. 1-4. The input operation method 500 includes the steps outlined below (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 501 an input interface 15 of a second program is displayed by the touch display unit 12, wherein the input interface 15 comprises a plurality of virtual keys 150.

In step 502, whether a first program activation signal 17 is received by the processing unit 14 when the input interface 15 is displayed on the touch display unit 12 is determined by processing unit 14.

When the processing module 14 determines that it does not receive the first program activation signal 17, the flow goes back to step 502 to keep performing the determining step. When the processing module 14 determines that it receives the first program activation signal 17, the processing module 14 executes the first program 11 in the storage unit 10 in step 503.

In step 504, the processing module 14 processes the operation input of the input interface 15 according to the first program 11.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A handheld electronic device, comprising:
a storage unit to store a first program;
a touch display unit to display an input interface of a second program, wherein the input interface comprises a plurality of virtual keys; and
a processing unit electrically connected to the storage unit and the touch display unit to determine that a first program activation signal is received when the input interface is displayed on the touch display unit and to execute the first program in the storage unit such that the first program processes the operation input of the input interface.

2. The handheld electronic device of claim 1, wherein the touch display unit displays a first interface corresponding to the first program on a second interface corresponding to the second program when the processing unit executes the first program stored in the storage unit.

3. The handheld electronic device of claim 2, wherein the first interface does not fully cover the second interface.

4. The handheld electronic device of claim 1, wherein the input interface further comprises an output key, and the processing unit outputs an operation result corresponding to the operation input of the input interface processed by the first program to the second program when the processing unit determines that the output key is triggered.

5. The handheld electronic device of claim 1, wherein the first program is tool software of a calculator, a dictionary, a notebook or a network search engine.

6. The handheld electronic device of claim 1, wherein the first program activation signal is generated by triggering a first program activation key further comprised by the input interface,

7. The handheld electronic device of claim 1, wherein the first program activation signal is generated by receiving a touch track or a touch gesture by the touch display unit.

8. The handheld electronic device of claim 1, further comprising a physical key and the first program activation signal is generated by triggering the physical key.

9. An input operation method used in a handheld electronic device, wherein the handheld electronic device comprises a storage unit to store a first program, a touch display unit and a processing unit electrically connected to the storage unit and the touch display unit, the input operation method comprises:
displaying an input interface of a second program by the touch display unit, wherein the input interface comprises a plurality of virtual keys
determining that a first program activation signal is received by the processing unit when the input interface is displayed on the touch display unit;
executing the first program in the storage unit by the processing unit; and
processing the operation input of the input interface by the processing unit according to the first program.

10. The input operation method of claim 9, further comprising displaying a first interface corresponding to the first program on a second interface corresponding to the second program by the touch display unit.

11. The input operation method of claim 10, wherein the first interface to does not fully cover the second interface.

12. The input operation method of claim 9, further comprising:
determining that an output key comprised by the input interface is triggered by the processing unit; and
outputting an operation result corresponding to the operation input of the input interface processed by the first program to the second program by the processing unit.

13. The input operation method of claim 9, wherein the first program is tool software of a calculator, a dictionary, a notebook or a network search engine.

14. The input operation method of claim 9, further comprising triggering a first program activation key further comprised by the input interface to generate the first program activation signal.

15. The input operation method of claim 9, further comprising receiving a touch track or a touch gesture by the touch display unit to generate the first program activation signal.

16. The input operation method of claim 9, further comprising triggering a physical key to generate the first program activation signal.
